(19) United States
(12) Patent Application Publication
(10) Pub. No.: US 2014/0008287 A1
(43) Pub. Date: Jan. 9, 2014

(54) INJECTOR FILTER AND METHOD OF MANUFACTURING THE SAME

(71) Applicant: HYUNDAI MOTOR COMPANY, Seoul (KR)

(72) Inventors: Kyungwook Baek, Seoul (KR); Moonsung Shin, Gunpo-si (KR)

(73) Assignees: Kefico Corporation, Gunpo-si (KR); Hyundai Motor Company, Seoul (KR)

(21) Appl. No.: 13/675,551

(22) Filed: Nov. 13, 2012

(30) Foreign Application Priority Data
Jul. 3, 2012 (KR) 10-2012-0072092

(51) Int. Cl. B01D 29/90; B23P 15/00

(52) U.S. Cl. CPC B01D 29/90; B23P 15/00
USPC 210/416.4; 29/888.01

(57) ABSTRACT

An injector filter of an injector may include a filter frame being seated on an inner side surface of the housing and having a bush coupling portion at an upper portion thereof, wherein a rotation prevention groove may be concavely formed on the bush coupling portion, nets coupled to the filter frame and having a mesh form to filter out the foreign matter contained in the fuel, and a bush coupled to the bush coupling portion and having a rotation prevention protrusion which protrudes from an inner side surface of the bush and may be inserted into the rotation prevention groove of the filter frame.

### CROSS-REFERENCE(S) TO RELATED APPLICATIONS

The present application claims priority to Korean Patent Application No. 10-2012-0072092, filed on Jul. 3, 2012, the entire contents of which is incorporated herein for all purposes by this reference.

### BACKGROUND OF THE INVENTION

1. Field of the Invention

Exemplary embodiments of the present invention relate to an injector for injecting fuel in an engine; and, particularly, to an injector filter, which is mounted to an injector, in which an upper portion of the injector filter and a bush are able to be maintained in a state of being securely coupled to each other, and a method of manufacturing the same.

2. Description of Related Art

A vehicle engine is provided with an injector used to inject fuel.

FIG. 1 shows a schematic structure of such an injector. As shown in FIG. 1, the injector 1 includes a plunger 13 reciprocatably mounted within a housing 11 and an injector filter 120 provided at an upper portion of the housing 11. The plunger 13 presses and injects fuel according to a signal input through a connector 12, and the injector filter 120 serves to remove foreign matter contained in fuel which is introduced into the injector 1.

FIG. 2 shows a cross-sectional structure of the injector filter 120, and FIG. 3 shows a structure exploded from an assembled state of the injector filter 120. As shown in FIGS. 2 and 3, the injector filter 120 has a structure in which a filter frame 121 is provided with nets 122, and thus foreign matter is removed while fuel passes through the nets 122. The injector filter 120 is mounted, in a state of being coupled with a metal bush 123 to an upper end thereof, to the housing 11, and is maintained in a state of being seated within the housing 11 by the bush 123.

Specifically, the injector filter 120 includes the filter frame 121, which is formed, at an upper portion thereof, with a bush coupling portion 121a and is formed with rotation prevention grooves 121b around the bush coupling portion 121a while having opening portions at central and lower portions thereof, the nets 122 which are arranged at the filter frame 121 and filter out foreign matter, and the bush 123 which is coupled to an outer side of the bush coupling portion 121a and is formed with rotation prevention protrusions 123a respectively inserted into the rotation prevention grooves 121b.

In such an injector filter 120, the upper portion of the filter frame 121 is securely supported to an inner side surface of the housing 11 by coupling of the bush 123 made of a brass material to the filter frame 121 made of a synthetic resin. The bush 123 is prevented from rotating about the filter frame 121 since the rotation prevention protrusions 123a are inserted into the rotation prevention grooves 121b, respectively.

However, the injector filter 120 of the related art having the above-mentioned structure is configured such that the filter frame 121 made of a synthetic resin and the bush 123 is coupled in a manner in which the rotation prevention protrusions 123a are inserted into the rotation prevention grooves 121b. As a result, there is a problem in that the rotation prevention protrusions 123a are easily damaged according to deformation of the filter frame 121.

In order to form the rotation prevention protrusions 123a at the bush 123, each of the rotation prevention protrusion 123a is formed in such a manner that the bush 123 is cut, at one side thereof, using a tool T and is then bent, as shown in FIG. 4. Therefore, although the rotation of the rotation prevention protrusion 123a may be prevented by the bush 123, the rotation prevention protrusion 123a has a structure in which damage is easily caused with respect to deformation due to movement in upward and downward directions.

Particularly, in the case of using synthetic gasoline as fuel, the filter frame 121 made of a synthetic resin reacts with the synthetic gasoline to cause expanding deformation of the filter frame 121 and damage of the rotation prevention protrusions 123a due to the operation of the injector 1 and a vibration of a vehicle, thereby often resulting in a phenomenon in which the rotation prevention protrusions 123a are removed from the bush 123.

As described above, when the rotation prevention protrusions 123a are damaged, the removed rotation prevention protrusions 123a move within the injector 1 along the flow of fuel and move to a sealing region between the housing 11 and the plunger 13, thereby being fixed to the sealing region and deteriorating sealing therebetween. As a result, there is a problem in that poor combustion is caused due to leakage of fuel during the non-operation (case of not injecting fuel) of the injector 1.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an injector filter in which a bush is able to be maintained in a state of securely adhering closely to a filter frame of the injector filter, and a method of manufacturing the same.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In an aspect of the present invention, an injector filter of an injector including a housing and a plunger reciprocatably mounted within the housing so as to press and inject fuel, the injector filter being provided at an upper portion of the housing and filtering out foreign matter contained in the fuel which is introduced into the housing, may include a filter frame being seated on an inner side surface of the housing and having a bush coupling portion at an upper portion thereof, wherein a rotation prevention groove is concavely formed on the bush coupling portion, nets coupled to the filter frame and having a mesh form to filter out the foreign matter contained in the fuel, and a bush coupled to the bush coupling portion and having a rotation prevention protrusion which protrudes from an inner side surface of the bush and is inserted into the rotation prevention groove of the filter frame.

The bush is formed, at circumferences of upper and lower ends thereof, with grip portions bent toward a center of the bush so as to grasp an upper end and a lower end of the filter frame.

The bush may have a ring shape and is located at the upper portion of the filter frame, and the rotation prevention protrusion is formed by punching the bush toward a center thereof from an outer side thereof corresponding to a portion formed with the rotation prevention groove of the filter frame, such that the rotation prevention protrusion is inserted into the associated rotation prevention groove.

The bush coupling portion of the filter frame is formed with a plurality of rotation prevention grooves which are spaced apart from one another along a circumference of the bush coupling portion, and a plurality of rotation prevention protrusions are formed on the inner side surface of the bush at respective positions corresponding to the rotation prevention grooves.

In another aspect of the present invention, a method of manufacturing an injector filter may include forming a bush which is formed, at a circumference of an outer side thereof, with rotation prevention protrusions, and which is formed, at upper and lower ends thereof, with grip portions bent inwards of the bush, the rotation prevention protrusions being spaced apart from one another and being punched inwards of the bush, and injecting a molten resin for inserting the formed bush into a mold and then infusing the resin so that a filter frame is produced in a state of being coupled to the bush.

The injecting of the resin may include seating the bush at an inner mold of the mold and closing outer sides of the bush and the inner mold by an outer mold, infusing the molten resin into a space defined between an outer side surface of the inner mold and an inner side surface of the outer mold, and extracting an injector filter by removal of the inner mold and the outer mold when the molten resin is cured.

The forming of the bush may include deep-drawing a metal plate so as to form the bush having a cylindrical shape, punching the deep-drawn bush having the cylindrical shape inwards of the bush so that the rotation prevention protrusions are formed to be spaced apart from one another along the circumference of the outer side of the bush, piercing a bottom surface of the deep-drawn bush so as to open the bottom surface thereof, and curling the upper and lower ends of the deep-drawn bush so that the upper and lower ends are bent inwards of the bush to form the grip portions.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a partially cut-away perspective view illustrating a conventional injector for a vehicle.

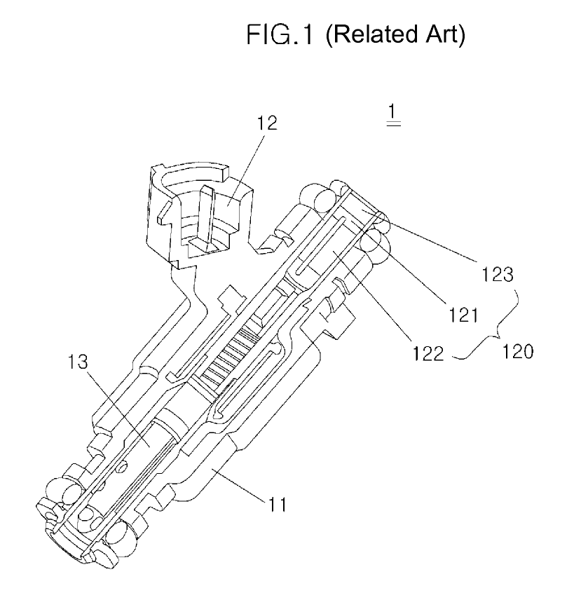

FIG. 2 is a cross-sectional view illustrating the injector filter of the related art.

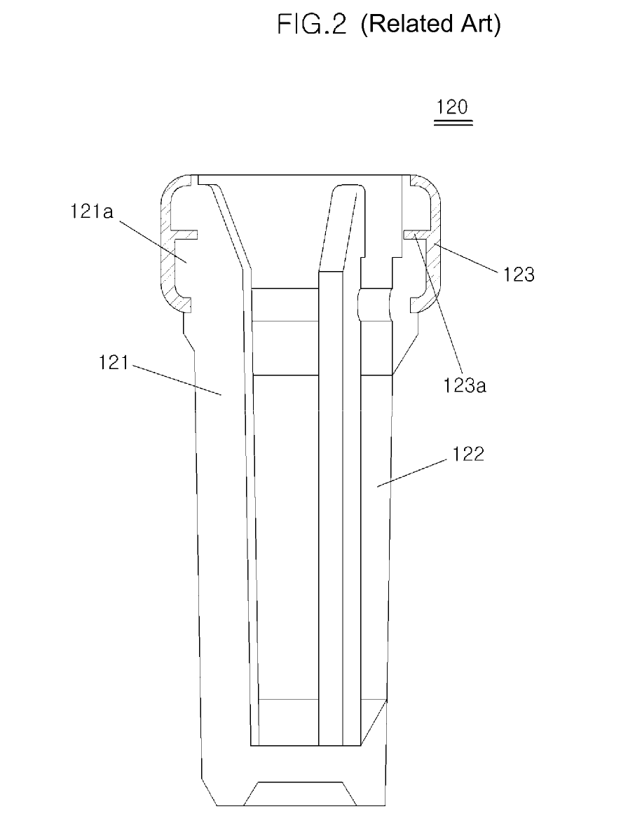

FIG. 3 is an exploded perspective view separately illustrating a filter frame and a bush in the injector filter of the related art.

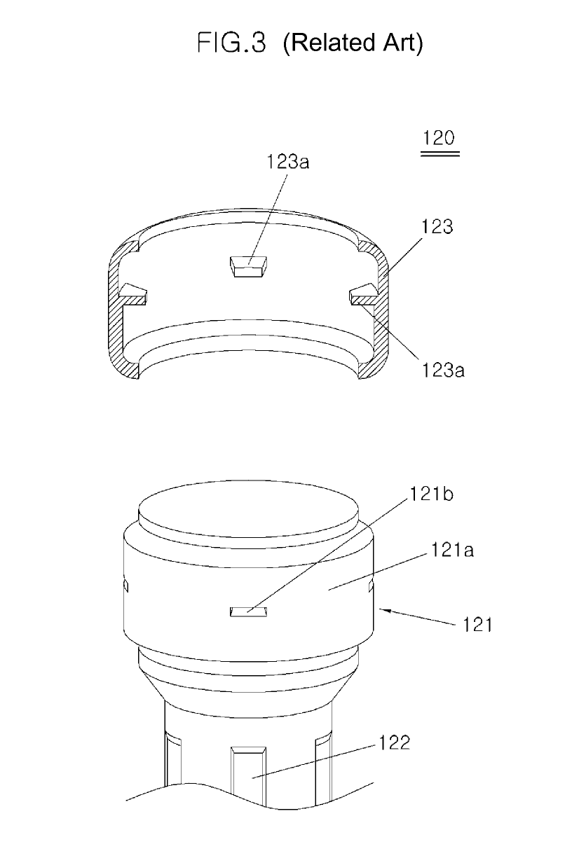

FIG. 4 is a view schematically illustrating a state of forming rotation prevention protrusions at the bush in the injector filter of the related art.

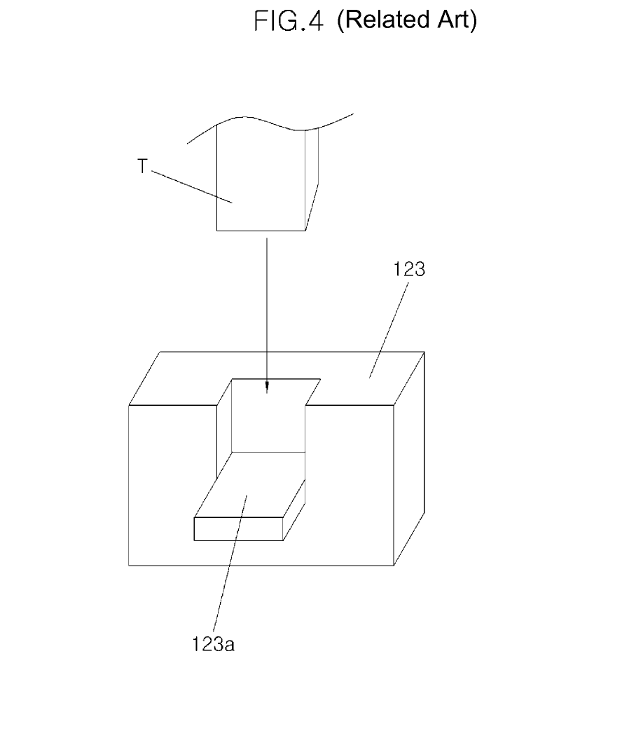

FIG. 5 is a cross-sectional view illustrating an injector filter in accordance with an exemplary embodiment of the present invention.

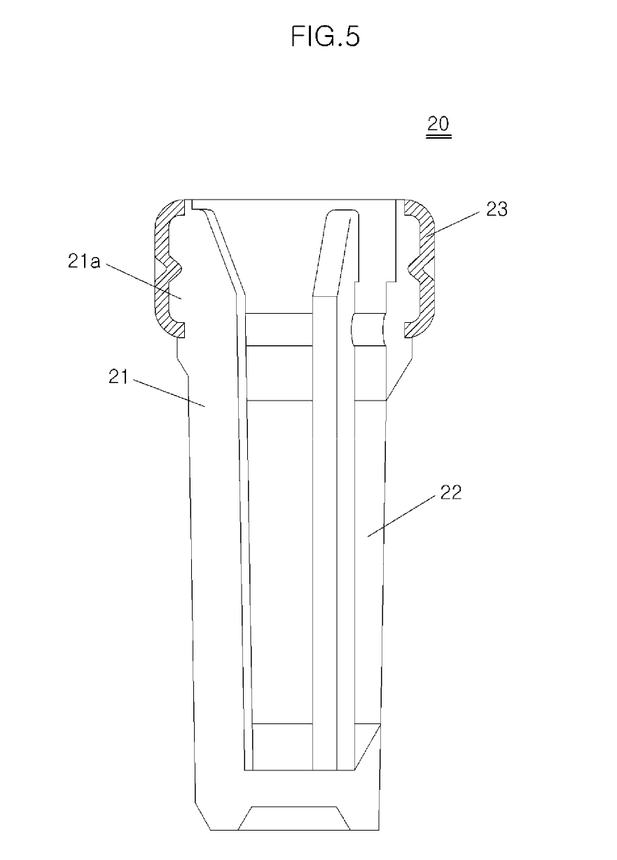

FIG. 6 is an exploded perspective view illustrating a state of separating a bush from the injector filter in accordance with the exemplary embodiment of the present invention.

FIG. 7 is a cross-sectional view illustrating the formation of rotation prevention grooves and grip portions at the bush in the injector filter in accordance with the exemplary embodiment of the present invention.

FIG. 8 is a flowchart illustrating a method of manufacturing the injector filter in accordance with the exemplary embodiment of the present invention.

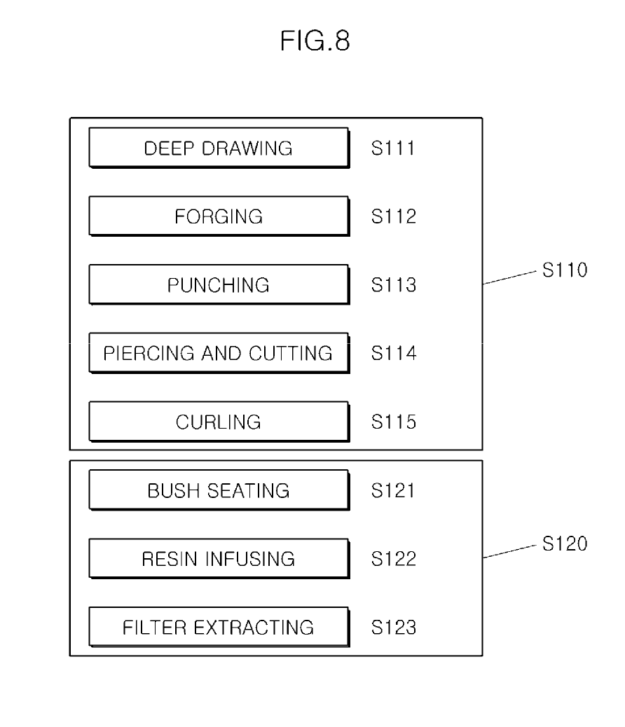

FIG. 9 is view schematically illustrating a forming process of the bush in the method of manufacturing an injector filter in accordance with the exemplary embodiment of the present invention.

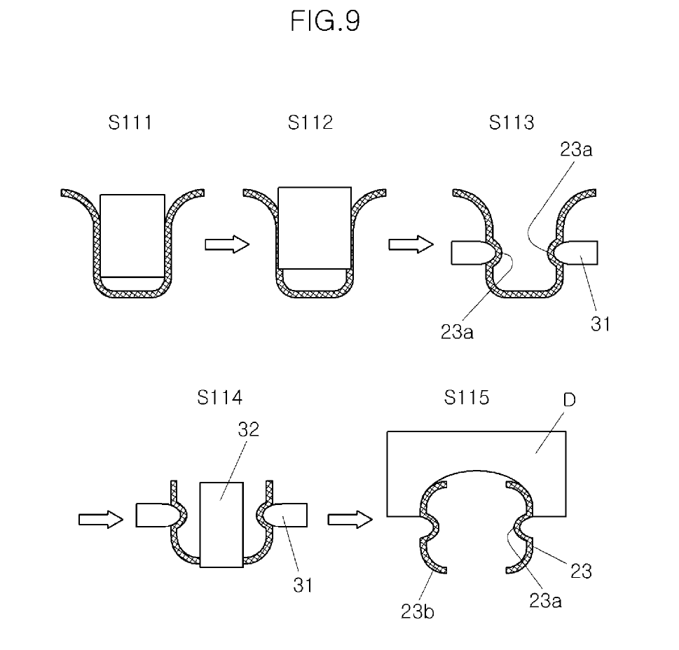

FIG. 10 is a view schematically illustrating a process of injecting a filter frame into the bush in the method of manufacturing an injector filter in accordance with the exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

The drawings are not necessarily to scale and in some instances, proportions may have been exaggerated in order to clearly illustrate features of the exemplary embodiments. When a first layer is referred to as being “on” a second layer or “on” a substrate, it not only refers to a case where the first layer is formed directly on the second layer or the substrate but also a case where a third layer exists between the first layer and the second layer or the substrate.

Hereinafter, an injector filter in accordance with an exemplary embodiment of the present invention will be described in detail with reference to the drawings.

The injector filter, which is designated by reference numeral 20, in accordance with the exemplary embodiment of the present invention includes a filter frame 21 which is formed, at an outer side of an upper portion thereof, with rotation prevention grooves 21b being spaced apart from one another, and a bush 23 which covers an upper circumference of the filter frame 21 while formed with rotation prevention protrusions 23a which are respectively inserted into the rotation prevention grooves 21b formed at the filter frame 21, the rotation prevention protrusions 23a being formed to protrude inwards of the bush 23.

The filter frame 21 is located at an upper portion of an injector 1. The filter frame 21 is formed, at an upper portion thereof, with a bush coupling portion 21a, which is seated at an inner side portion of a housing 11 of an injector 1 and coupled with the bush 23 to be described later, and is formed, at central and lower portions thereof, with opening portions to pass through fuel. The rotation prevention grooves 21b are formed to be spaced apart from one another around an upper end of the filter frame 21 and concavely formed to be directed inwards. Each of the rotation prevention grooves 21b has a cross-sectional area which is narrowed as going inwards, such as a hemisphere or conical shape. The four rotation prevention grooves 21b are preferably formed around the bush coupling portion 21a with equal intervals. Such a filter frame 21 is made of a synthetic resin.

The filter frame 21 is provided with nets 22 to cover the opening portions thereof Each of the nets 22 has a mesh form, and serves to remove foreign matter contained in fuel by filtering out the foreign matter while the fuel passes through the net 22.

The bush 23 is coupled to an outer side of the bush coupling portion 21a of the filter frame 21 so as to cover the upper end of the filter frame 21. The bush 23 has a ring shape. The bush 23 is bent, at circumferences of the upper and lower ends thereof, inwards so as to securely grasp the upper portion of the filter frame 21 when coupled to the filter frame 21.

The bush 23 is formed, along an inner circumference thereof, with the rotation prevention protrusions 23a inserted into the rotation prevention grooves 21b. The rotation prevention protrusions 23a have the same number as the rotation prevention grooves 21b at respective positions corresponding to the rotation prevention grooves 21b. The rotation prevention protrusions 23a are formed at the positions corresponding to the rotation prevention grooves 21b and maintained in a state of being inserted into the rotation prevention grooves 21b, respectively, such that the bush 23 is maintained in a state of being securely coupled to the filter frame 21.

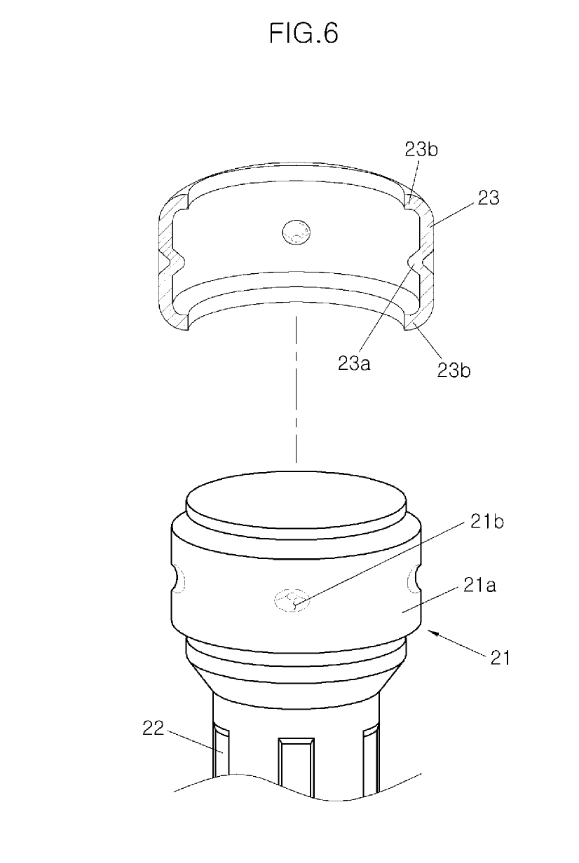

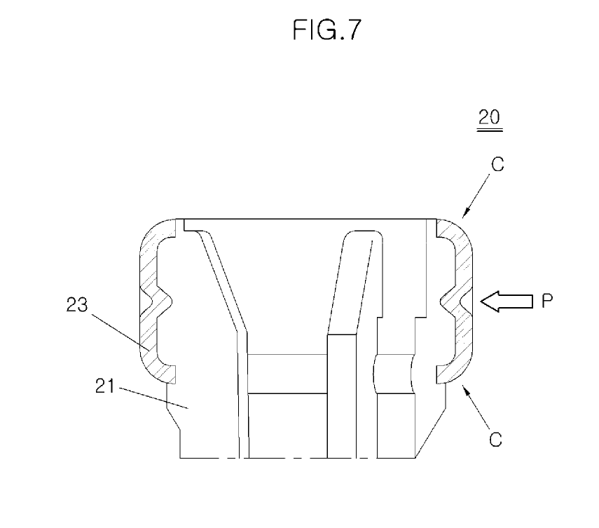

Meanwhile, the bush 23 finally has a shape as shown in FIG. 6. In other words, the bush 23 is initially manufactured of a simple ring or cylindrical shape, and then has a final shape by post-processing such as punching and curling as shown in FIG. 7.

That is, as shown in FIG. 6, the bush 23 is first manufactured without the formation of the rotation prevention protrusions 23a and the process of the upper and lower ends thereof, and is then formed through the processes of punching and curling the bush 23 toward a center thereof from an outer side thereof.

Each of the rotation prevention protrusions 23a is formed at the bush 23 having a ring or cylindrical shape by punching an outer side surface of the bush 23, which corresponds to a position where the rotation prevention protrusions 23a is to be formed, in a direction indicated by the arrow P using a punch for punching 31. As described above, the rotation prevention protrusions 23a is formed at the bush 23 by the punching process, and thus the rotation prevention protrusions 23a of the bush 23 is inserted into the associated rotation prevention groove 21b of the filter frame 21 in the injector filter 20 which is finally completed.

In addition, the circumferences of the upper and lower ends of the bush 23 are performed by the curling process so as to grasp the bush coupling portion 21a of the filter frame 21. As shown in FIG. 7, by applying an external force to the circumferences of the upper and lower ends of the bush 23 in a direction indicated by the arrow C so that the upper and lower ends of the bush 23 are bent inwards, the upper and lower ends of the bush 23 are processed to form grip portions 23b for grasping upper and lower ends of the bush coupling portion 21a of the filter frame 21. Since the grip portions 23b by which the upper and lower ends of the bush 23 grasp the upper and lower ends of the filter frame 21 are formed by the curling process, the bush 23 is prevented from moving in upward and downward directions with respect to the filter frame 21.

Hereinafter, a method of manufacturing the injector filter in accordance with the exemplary embodiment of the present invention will be described as follows.

The method of manufacturing the injector filter in accordance with the exemplary embodiment of the present invention includes a bush forming step S110 for forming the bush 23 which is formed in a cylindrical shape using a metal plate, formed, at the circumference thereof, with the rotation prevention protrusions 23a, and formed, at the upper and lower ends thereof, with the grip portions 23b, and a resin injecting step S120 for injecting a resin so as to form the filter frame 21 extending downwards of the bush 23 from the inner side surface thereof.

The bush forming step S110 includes a deep drawing step S111 for producing an intermediate product of the bush 23 having a cylindrical shape by deep drawing the metal plate, a punching step S113 for forming the rotation prevention protrusions 23a by punching the circumference of the outer side surface of the bush 23, a piercing and cutting step S114 for removing a bottom surface and unnecessary portion of the bush 23, and a curling step S115 for forming the grip portions 23b by bending the upper and lower ends of the cylindrical bush 23 in the inward direction.

At the deep drawing step S111, the bush 23 becomes an essential shape, namely, a cylindrical shape through the deep drawing process of the metal plate. After the deep drawing process, the bush 23 is opened at the upper end thereof, but the bottom surface of the bush 23 still remains at the lower end thereof.

The bush forming step S110 further includes a forging step S112 for forging the inside of the intermediate product of the bush 23 having a cylindrical shape through the deep drawing process so that the bush 23 becomes closer to a finally cylindrical shape and the inner structure thereof is securely made.

The punching step S113 is a process for forming the rotation prevention protrusions 23a on the side surface of the bush 23 by punching the side surface of the intermediate product of the bush 23 using the punch for punching 31. The punch 31 is punched toward the inner side surface of the bush 23 from the outer side surface thereof along the circumference thereof at regular intervals, for example, 90 degrees intervals, such that the rotation prevention protrusions 23a are formed at the bush 23.

The piercing and cutting step S114 removes the bottom surface from the intermediate product of the bush 23 using a punch for piercing 32, such that the intermediate product of the bush 23 is opened at the bottom thereof. Further, the piercing and cutting step S114 cuts the unnecessary portion from the intermediate product of the bush 23, and thus the bush 23 has a cylindrical structure, and is formed with the rotation prevention protrusions 23a at the circumference thereof.

The curling step S115 is a process of being formed so that the bush 23 grasps the filter frame 21 by bending the respective upper and lower ends of the bush 23 in the inward direction. The grip portions 23b are respectively formed at the upper and lower ends of the bush 23 by bending the upper and lower ends thereof having a cylindrical shape toward an axial center thereof using a die D.

The resin injecting step S120 includes a bush seating step S121 for seating the bush 23 within a mold, a resin infusing step S122 for infusing the molten resin into the mold and coupling the bush 23 to the filter frame 21, and a filter extracting step S123 for extracting the completed injector filter 20 from the mold.

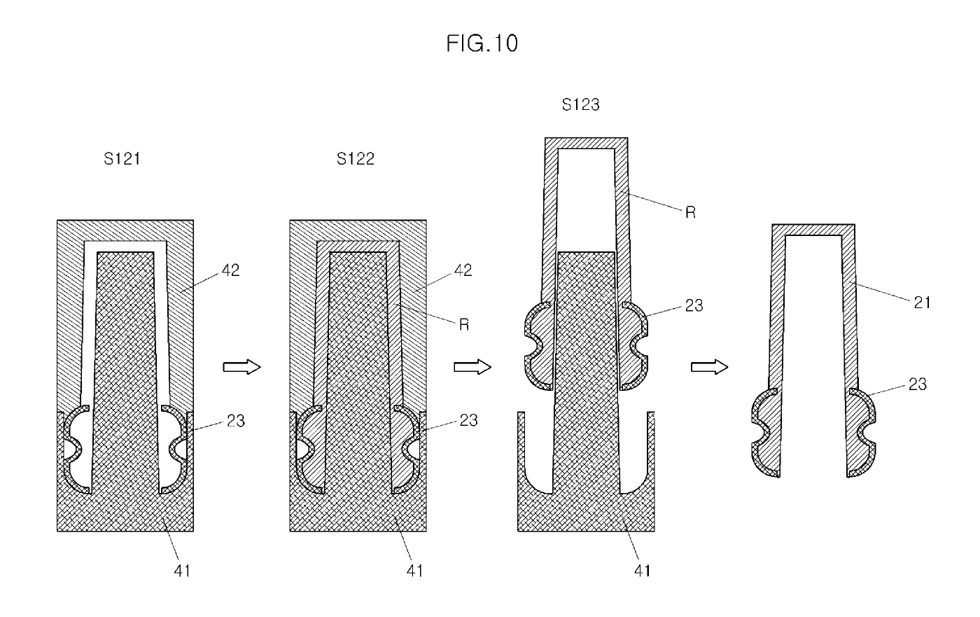

In this case, since the bush 23 is preferably located at the bottom of the mold so that the molten resin is easily infused when infused into the mold, the resin injecting step S120 is performed in a state of reversing an up-and-down position, as shown in FIG. 10.

The bush seating step S121 is a process of seating the bush 23 at which processing is completed within the mold. The mold to process the injector filter 20 includes an inner mold 41 and an outer mold 42.

The inner mold 41 is protrusively formed at a central portion thereof so as to define a space within the injector filter 20.

The outer mold 42 is formed so as to be coupled to an outer side of the inner mold 41 at which the bush 23 is seated, and a space is defined between an inner side surface of the outer mold 42 and inner side surfaces of the bush 23 and the inner mold 41 so as to infuse the resin.

As described above, when the bush 23 is seated within the mold, the resin infusing step S122 is performed in which the molten resin R is infused into the space defined between the outer mold 42 and the inner mold 41.

At the resin infusing step S122, in order to fill the inner side of the bush 23 with the resin and extend the filter frame 21 downwards of the bush 23 in the completed injector filter 20, the resin is also infused from the insides of the inner and outer molds 41 and 42 to the upper portion of the bush 23 in FIG. 10 shown as the state of reversing the up-and-down position.

As described above, when the molten resin R is infused into the mold and is then cured, the completed injector filter 20 is extracted by removal of the outer and inner molds 42 and 41. As above, when the filter frame 21 is formed by curing the resin at the inner side of the bush 23, the nets 22 are attached to the inner side of the filter frame 21. As a result, the injector filter 20 is completed.

According to the injector filter having the above-mentioned structure and the method of manufacturing the same in accordance with the exemplary embodiment of the present invention, the bush 23 is maintained in the state of being securely coupled to the filter frame 21 by virtue of the punching and curling processes.

Accordingly, even when the filter frame 21 is deformed using synthetic gasoline, the bush 23 may be prevented from being separated from the filter frame 21. Particularly, since the rotation prevention protrusions 23a are formed at the bush 23 by the punching process and are inserted into the rotation prevention grooves 21b of the filter frame 21, the bush 23 may be maintained in the state of being fastened to the filter frame 21 without a reduction in strength of the bush 23.

In accordance with the exemplary embodiments of the present invention, in the case of an injector filter having the above-mentioned structure and a method of manufacturing the same, since the coupling between a filter frame and a bush in the injector filter is achieved by insertion of rotation prevention protrusions into rotation prevention grooves having a hemisphere or conical shape, the bush may securely cover the filter frame in the injector filter.

Also, since a method of coupling the bush to the filter frame is accomplished in such a way that the bush is first formed and a resin is injected in a state of inserting the bush into a mold, it may simply facilitate the secure coupling between the bush and the filter frame.

Furthermore, the bush is prevented from being separated from the filter frame by a method of punching a portion of the bush, instead of cutting and bending a portion of the thickness of the bush, thereby not causing a reduction in strength of the bush. Accordingly, it may prevent a phenomenon in which a portion of the bush is damaged and the injector is not functioned properly.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An injector filter of an injector including a housing and a plunger reciprocatably mounted within the housing so as to press and inject fuel, the injector filter being provided at an upper portion of the housing and filtering out foreign matter contained in the fuel which is introduced into the housing, the injector filter comprising:
a filter frame being seated on an inner side surface of the housing and having a bush coupling portion at an upper portion thereof, wherein a rotation prevention groove is concavely formed on the bush coupling portion;
nets coupled to the filter frame and having a mesh form to filter out the foreign matter contained in the fuel; and
a bush coupled to the bush coupling portion and having a rotation prevention protrusion which protrudes from an inner side surface of the bush and is inserted into the rotation prevention groove of the filter frame.

2. The injector filter of claim 1, wherein the bush is formed, at circumferences of upper and lower ends thereof, with grip portions bent toward a center of the bush so as to grasp an upper end and a lower end of the filter frame.

3. The injector filter of claim 1, wherein the bush has a ring shape and is located at the upper portion of the filter frame, and the rotation prevention protrusion is formed by punching the bush toward a center thereof from an outer side thereof corresponding to a portion formed with the rotation prevention groove of the filter frame, such that the rotation prevention protrusion is inserted into the associated rotation prevention groove.

4. The injector filter of claim 1, wherein:
the bush coupling portion of the filter frame is formed with a plurality of rotation prevention grooves which are spaced apart from one another along a circumference of the bush coupling portion; and
a plurality of rotation prevention protrusions are formed on the inner side surface of the bush at respective positions corresponding to the rotation prevention grooves.

5. A method of manufacturing an injector filter comprising:
forming a bush which is formed, at a circumference of an outer side thereof, with rotation prevention protrusions, and which is formed, at upper and lower ends thereof, with grip portions bent inwards of the bush, the rotation prevention protrusions being spaced apart from one another and being punched inwards of the bush; and
injecting a molten resin for inserting the formed bush into a mold and then infusing the resin so that a filter frame is produced in a state of being coupled to the bush.

6. The method of manufacturing the injector filter of claim 5, wherein the injecting of the resin comprises:
seating the bush at an inner mold of the mold and closing outer sides of the bush and the inner mold by an outer mold;
infusing the molten resin into a space defined between an outer side surface of the inner mold and an inner side surface of the outer mold; and
extracting an injector filter by removal of the inner mold and the outer mold when the molten resin is cured.

7. The method of manufacturing the injector filter of claim 5, wherein the forming of the bush comprises:
deep-drawing a metal plate so as to form the bush having a cylindrical shape;
punching the deep-drawn bush having the cylindrical shape inwards of the bush so that the rotation prevention protrusions are formed to be spaced apart from one another along the circumference of the outer side of the bush;
piercing a bottom surface of the deep-drawn bush so as to open the bottom surface thereof; and
curling the upper and lower ends of the deep-drawn bush so that the upper and lower ends are bent inwards of the bush to form the grip portions.

8. The method of manufacturing the injector filter of claim 7, wherein the injecting of the resin comprises:
seating the bush at an inner mold of the mold and closing outer sides of the bush and the inner mold by an outer mold;
infusing the molten resin into a space defined between an outer side surface of the inner mold and an inner side surface of the outer mold; and
extracting an injector filter by removal of the inner mold and the outer mold when the molten resin is cured.
